(19) United States
(12) Patent Application Publication
(10) Pub. No.: US 2005/0237461 A1
(43) Pub. Date: Oct. 27, 2005

(54) Liquid crystal display and panel therefor

(76) Inventors: Nak-Cho Choi, Seoul (KR); Doo-Hwan You, Suwon-si (KR); Mee-Hye Jung, Hwaseong-si (KR)

Correspondence Address: MCGUIREWOODS, LLP, 1750 TYSONS BLVD, SUITE 1800, MCLEAN, VA, 22102, US

(21) Appl. No.: 11/110,875

(22) Filed: Apr. 21, 2005

(30) Foreign Application Priority Data
Apr. 22, 2004 (KR) 10-2004-0027822
Apr. 18, 2005 (KR) 10-2005-0031940

(51) Int. Cl. G02F 1/1337

(52) U.S. Cl. 349/129

(57) ABSTRACT

A panel for a liquid crystal display is provided, which includes: a substrate; an insulating layer formed on the substrate, which includes a set of cutouts forming a plurality of domains; and a common electrode formed on the insulating layer, which includes a non-planar, or crooked surface, induced by the cutouts in the insulating layer.

### CROSS-REFERENCE TO RELATED APPLICATIONS

This application claims priority to and the benefit of Korean Patent Application No. 10-2004-0027822 filed in the Korean Intellectual Property Office on Apr. 22, 2004, and Korean Patent Application No. 10-2005-0031940 filed in the Korean Intellectual Property Office on Apr. 18, 2005, both of which are incorporated in their entirety herein by reference.

### BACKGROUND OF THE INVENTION

(a) Field of the Invention

The present invention relates to a liquid crystal display and a panel therefor.

(b) Description of the Related Art

A liquid crystal display (LCD) is one of the most widely used types of flat panel displays. An LCD may include two panels comprised of field-generating electrodes, such as pixel electrodes and a common electrode, with a liquid crystal (LC) layer interposed therebetween. The LCD displays images by applying voltages to the field-generating electrodes to generate an electric field in the LC layer, which determines the orientation of LC molecules in the LC layer to adjust polarization of incident light.

A vertical alignment (VA) mode LCD, which aligns LC molecules such that their longitudinal axes are perpendicular to the panels in absence of an electric field is preferred, because of its high contrast ratio and wide reference viewing angle that is defined either as a viewing angle making the contrast ratio equal to 1:10 or as a limit angle for the inversion of luminance between the grays.

The wide viewing angle of the VA mode LCD can be realized by including cutouts in the field-generating electrodes and protrusions on the field-generating electrodes. The cutouts and the protrusions can be used to vary the tilt directions of LC molecules such that they can be arranged into several different tilt directions in order to widen the reference viewing angle.

However, because the photolithography process to etch the field-generating electrodes must be added during the manufacture of VA LCDs having these cutouts, both the cost and time of production are increased. In addition, since the cutouts of the field-generating electrodes can accumulate charge carriers, which may damage the polarizers, an ESD treatment is also required to prevent damage to the polarizers.

### SUMMARY OF THE INVENTION

A motivation of the present invention is to solve the problems of the conventional art.

A panel for a liquid crystal display is provided, which includes: a substrate; a gate line and a data line formed on the substrate; a thin film transistor connected to the gate line and the data line; a passivation layer, which covers the gate line, the data line and the thin film transistor, including a set of protrusions that form a plurality of domains; and a pixel electrode, which is formed on the passivation layer, connected to the thin film transistor, including a non-planar surface that is induced by the protrusions on the passivation layer.

A panel for a liquid crystal display is provided, which includes: a substrate; an insulating layer formed on the substrate, which includes a set of cutouts that form a plurality of domains; and a common electrode, which is formed on the insulating layer, including a non-planar surface that is induced by the cutouts in the insulation layer.

A liquid crystal display is provided, which includes: a first substrate; a gate line and a data line formed on the first substrate; a thin film transistor connected to the gate line and the data line; a passivation layer, which covers the gate line, the data line and the thin film transistor, including a set of protrusions that form a plurality of domains; a pixel electrode, which is formed on the passivation layer and connected to the thin film transistor, including a non-planar surface that is induced by the protrusions on the passivation layer; a second substrate; an insulating layer formed on the second substrate; and a common electrode formed on the insulating layer.

A panel for a liquid crystal display is provided, which includes: a first substrate; a gate line and a data line formed on the first substrate; a thin film transistor connected to the gate line and the data line; a passivation layer covering the gate line, the data line and the thin film transistor; a pixel electrode formed on the passivation layer and connected to the thin film transistor; a second substrate; an insulating layer, which is formed on the second substrate, including a set of cutouts that form a plurality of domains; and a common electrode, which is formed on the insulating layer, including a non-planar surface induced by the cutouts in the insulating layer.

### BRIEF DESCRIPTION OF THE DRAWINGS

The present invention will become more apparent by describing embodiments thereof in detail with reference to the accompanying drawings.

FIG. 1 is a layout view of a TFT array panel of an LCD according to an embodiment of the present invention.

FIG. 2 is a layout view of a common electrode panel of an LCD according to an embodiment of the present invention.

FIG. 3 is a layout view of an LCD including the TFT array panel shown in FIG. 1, and the common electrode panel shown in FIG. 2.

FIG. 4 is a sectional view of the LCD shown in FIG. 3 taken along the line IV-IV′.

FIG. 5 is a sectional view of the LCD shown in FIG. 3 taken along the line V-V′.

FIG. 6 is a layout view of an LCD according to another embodiment of the present invention.

FIG. 7 is a sectional view of the LCD shown in FIG. 6 taken along the line VII-VII′.

FIG. 8 is a sectional view showing equipotential lines formed between a TFT array panel and a common electrode panel of a LCD according to the present invention.

FIG. 9 is a layout view of an LCD according to yet another embodiment of the present invention.

FIG. 10 is a sectional view of the LCD shown in FIG. 9 taken along the line X-X′.

FIG. 11 is a sectional view of the LCD shown in FIG. 9 taken along the line XI-XI′.

FIG. 12 is a sectional view of an LCD according to yet another embodiment of the present invention.

### DETAILED DESCRIPTION OF EMBODIMENTS

The present invention now will be described more fully hereinafter with reference to the accompanying drawings, in which preferred embodiments of the invention are shown. The present invention may, however, be embodied in many different forms and should not be construed as limited to the embodiments as set forth herein.

In the drawings, the thickness of layers, films and regions are exaggerated for clarity. Like numerals refer to like elements throughout. It will be understood that when an element such as a layer, film, region or substrate is referred to as being “on” another element, it can be directly on the other element or intervening elements may also be present. In contrast, when an element is referred to as being “directly on” another element, there are no intervening elements present.

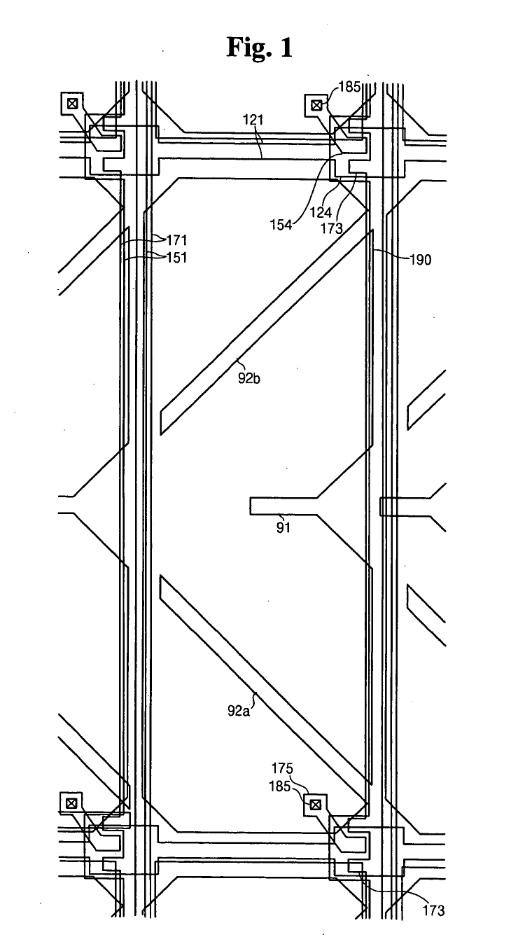

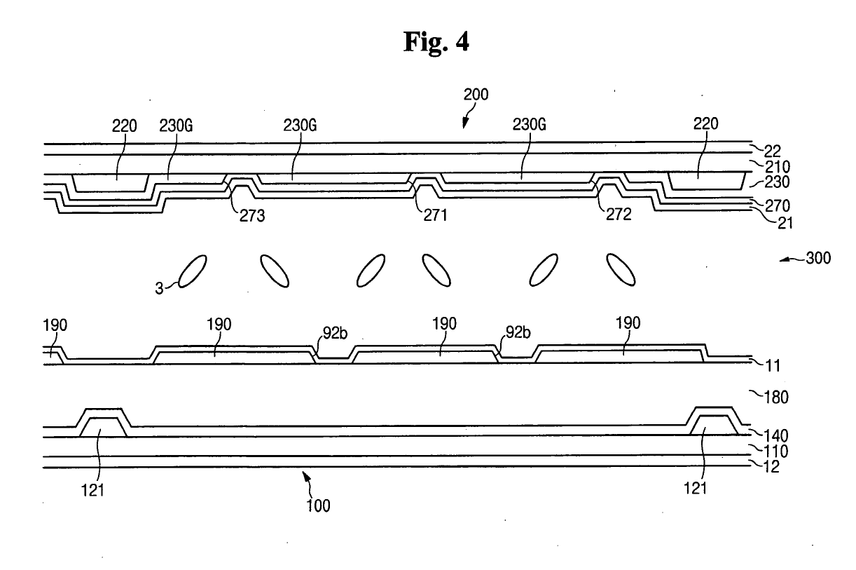

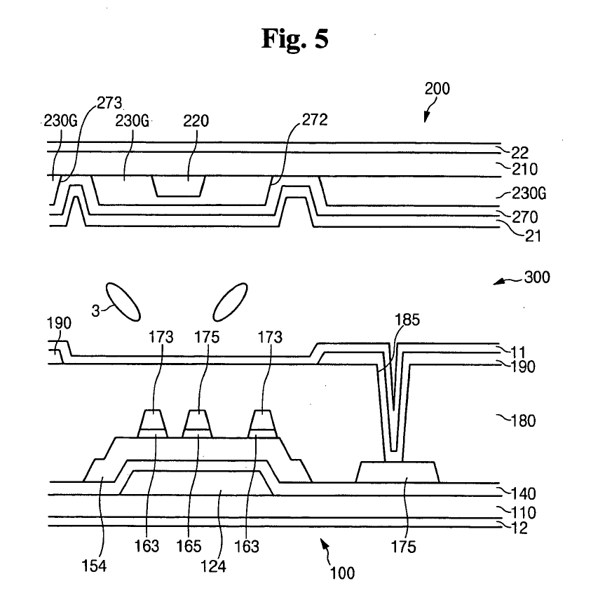

An LCD according to an embodiment of the present invention will be described in detail with reference to FIGS. 1-5.

An LCD according to an embodiment of the present invention includes a TFT array panel 100, a common electrode panel 200, and an LC layer 300 interposed between panels 100 and 200.

TFT array panel 100, as shown in FIGS. 1, 3, 4 and 5, includes a plurality of gate lines 121 that are formed on an insulating substrate 110 such as transparent glass.

Gate lines 121 that transmit gate signals extend substantially in a transverse direction and are separated from each other. Each gate line 121 includes a plurality of projections that form a plurality of gate electrodes 124. The end portions of each gate line 121 may have a large area for contact with another layer or an external driving circuit. Gate lines 121 may extend to be connected to a driving circuit that may be integrated on TFT array panel 100.

Gate lines 121 are preferably made of Al, Ag, Cu, Mo or an alloy containing one of these metals. Gates lines 121 can also be made of Cr, Ti or Ta. Gate lines 121 may have a multi-layered structure including two films having different physical characteristics. One of the two films is preferably made of low resistivity metal like Al, Ag or Cu, and reduces signal delay or voltage drop in gate lines 121 and storage electrode lines. The other film is preferably made of material such as Mo, Cr, Ta or Ti, which has good physical, chemical, and electrical contact properties with other materials such as indium tin oxide (ITO) or indium zinc oxide (IZO). Good examples of combinations of the two films are a lower Cr film and an upper Al—Nd alloy film or a lower Al film and an upper Mo film.

In addition, the lateral sides of gate lines 121 and the storage electrode lines are inclined relative to a surface of the substrate at an angle that ranges from 20-80 degrees.

A gate insulating layer 140, preferably made of silicon nitride (SiNx), is formed on gate lines 121 and the storage electrode lines.

A plurality of semiconductor stripes 151, preferably made of hydrogenated amorphous silicon (“a-Si”) or polysilicon, are formed on gate insulating layer 140. Each semiconductor stripe 151 extends substantially along the longitudinal axis of the pixel electrode 190 and has a plurality of projections 154 branched out toward gate electrodes 124. Semiconductor stripes 151 widen near gate lines 121 such that semiconductor stripes 151 overlap large areas of gate lines 121.

A plurality of ohmic contact stripes and islands 163 and 165, which are preferably made of silicide or n+ hydrogenated a-Si heavily doped with n-type impurity such as phosphorous, are formed on semiconductor stripes 151. Each ohmic contact stripe 163 has a plurality of projections, which, along with ohmic contact islands 165, are located on projections 154 of semiconductor stripes 151.

The lateral sides of semiconductor stripes 151 and ohmic contacts 163 and 165 are inclined relative to a surface of the substrate at an angle preferably in a range between about 30-80 degrees.

A plurality of data lines 171 and a plurality of drain electrodes 175, which are separated from data lines 171, are formed on ohmic contacts 163 and 165 and gate insulating layer 140.

Data lines 171 for transmitting data voltages extend substantially along the longitudinal axis of pixel electrode 190, crossing gate lines 121 at approximately right angles. Each data line 171 may include an end portion having a large area for contact with another layer or an external device. Each data line 171 includes a plurality of source electrodes 173 projecting toward the drain electrodes 175.

Each drain electrode 175 includes one end portion having a large area for contact with another layer and another end portion disposed on gate electrode 124 and partly enclosed by source electrode 173. Gate electrode 124, source electrode 173, and drain electrode 175, along with a projection 154 of semiconductor stripe 151, form a TFT having a channel formed in projection 154 disposed between source electrode 173 and drain electrode 175.

Data lines 171, and drain electrodes 175 are preferably made of a refractory metal such as Cr, Mo, Ti, Ta or alloys thereof. However, they may also have a multilayered structure including a low-resistivity film (not shown) and a good-contact film (not shown). A good example of the combination is a lower Mo film, an intermediate Al film, and an upper Mo film in addition to the above-described combinations of either a lower Cr film and an upper Al—Nd alloy film or a lower Al film and an upper Mo film.

Like gate lines 121 and the storage electrode lines, the data lines 171 and the drain electrodes 175 have tapered lateral sides, which are inclined relative to the substrate at an angle of about 30-80 degrees.

Ohmic contacts 163 and 165 reduce the contact resistance between the underlying semiconductor stripes 151 and the overlying data lines 171 and drain electrodes 175. Semiconductor stripes 151 include a plurality of exposed portions, which are not covered by data lines 171 or drain electrodes 175, such as those portions located between source electrodes 173 and drain electrodes 175. Although semiconductor stripes 151 are narrower than data lines 171 at most places, semiconductor stripes 151 widen near gate lines 121, as described above, to smooth the profile of the surface and thereby prevent the disconnection of data lines 171.

A passivation layer 180 is formed on data lines 171, drain electrodes 175, and exposed portions of semiconductor stripes 151. Passivation layer 180 is preferably made of an inorganic insulator such as silicon nitride or silicon oxide, a photosensitive organic material having a good flatness characteristic, or a low dielectric insulating material having dielectric constant lower than 4.0 such as a-Si:C:O and a-Si:O:F formed by plasma enhanced chemical vapor deposition (PECVD). Passivation layer 180 may have a double-layered structure including a lower inorganic film and an upper organic film.

Passivation layer 180 has a plurality of contact holes 185 exposing the end portions of drain electrodes 175. Passivation layer 180 may include a plurality of end portions of data lines 171 and gate lines 121 in addition to gate insulating layer 140.

A plurality of pixel electrodes 190, which are preferably made of a transparent conductor, such as ITO or IZO, or a reflective conductor such as Ag or Al, is formed on passivation layer 180.

Pixel electrodes 190 are physically and electrically connected to drain electrodes 175 through contact holes 185 such that pixel electrodes 190 receive the data voltages from drain electrodes 175.

Pixel electrodes 190 supplied with the data voltages generate electric fields in cooperation with the common electrode 270, which determine the orientation of LC molecules 3 in LC layer 300.

A pixel electrode 190 and common electrode 270 form a liquid crystal capacitor that stores applied voltages after TFT 100 is powered off. An additional capacitor called a “storage capacitor,” which is connected in parallel to the liquid crystal capacitor, provides additional voltage storage capacity. The storage capacitors may be formed by overlapping pixel electrodes 190 with storage electrode lines or the previous gate lines 121. Gate lines 121 may have both a plurality of expansions to increase storage capacitance and a plurality of conductors, which are connected to pixel electrodes 190 and may be added under passivation layer 180. Alternatively, a plurality of storage electrodes that overlap pixel electrodes 190 may be separately added to form the storage capacitor.

Each pixel electrode 190 is chamfered at its corners and the chamfered edges of pixel electrode 190 forms about a 45 degree angle with gate lines 121.

Each pixel electrode 190 has a lower cutout 92a, a center cutout 91, and an upper cutout 92b, which partition pixel electrode 190 into a plurality of partitions. Cutouts 91-92b are substantially symmetrical with respect to an imaginary transverse line bisecting pixel electrode 190.

Lower and upper cutouts 92a and 92b obliquely extend from the lower and upper corners, repectively, of the right edge of pixel electrode 190 to the center of the left edge of pixel electrode 190. Lower and the upper cutouts 92a and 92b are disposed at lower and upper halves of pixel electrode 190, respectively, which can be divided by the imaginary transverse line bisecting pixel electrode 190. Lower and the upper cutouts 92a and 92b are disposed at an angle of about 45 degrees from gate lines 121, and they extend substantially perpendicular towards each other.

Center cutout 91 extends along the imaginary transverse line and has an inlet at the right edge of pixel electrode 190 that has a pair of inclined edges, which are substantially parallel to the corresponding lower and upper cutouts 92a, 92b.

Accordingly, the lower half of pixel electrode 190 is partitioned into two lower partitions by lower cutout 92a and the upper half of pixel electrode 190 is also partitioned into two upper partitions by upper cutout 92b. The number of partitions or cutouts is varied depending on design factors such as: the size of pixels, the ratio of the transverse edges and the longitudinal edges of the pixel electrodes, the type and characteristics of LC layer 300, for example

A plurality of contact assistants may also be added. The contact assistants are connected to the end portions of gate lines 121 and data lines 171 through the contact holes 185 of the passivation layer 180 and gate insulating layer 140, respectively. The contact assistants protect the end portions of gate lines 121 and data lines 171 and complement the adhesion of the end portions the gate lines 121 and the data lines 171 to external devices.

Pixel electrodes 190 may overlap gate lines 121 and data lines 171 to increase the aperture ratio by inserting a passivation layer 180 having low dielectric insulating material therebetween.

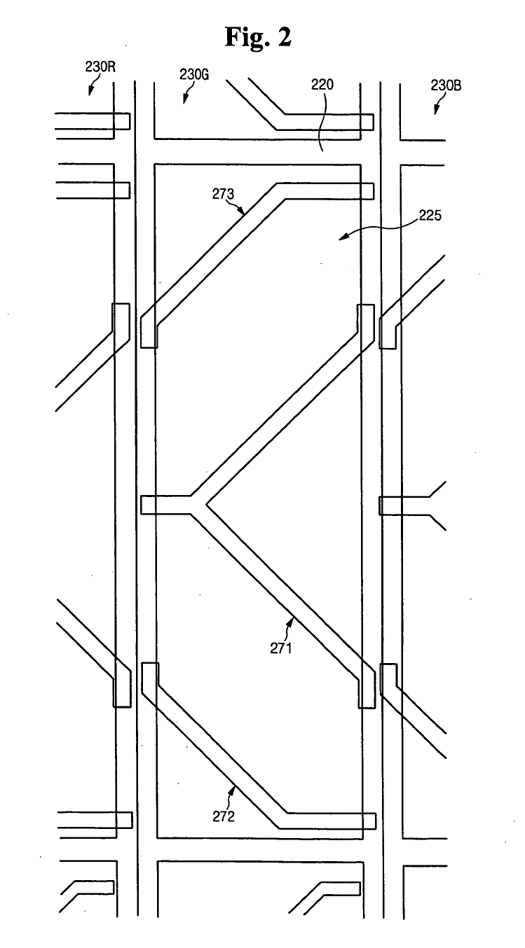

The description of common electrode panel 200, as shown in FIGS. 2-5, follows.

A light blocking member 220 for preventing light leakage, which is known as a black matrix, is formed on an insulating substrate 210 such as transparent glass. Light blocking member 220 may include a plurality of openings 225 that face pixel electrodes 190 and may have substantially the same planar shape as pixel electrodes 190. Otherwise, light blocking member 220 may include linear portions corresponding to the data lines 171 and other portions corresponding to the TFTs.

A plurality of color filters 230R, 230G, 230B are formed on the substrate 210 and they are disposed substantially in an area enclosed by light blocking member 220. Color filters 230R, 230G, 230B extend substantially along the longitudinal axes of pixel electrodes 190. Color filters 230R, 230G, 230B may represent one of the primary colors such as red, green and blue, respectively.

Color filters 230R, 230G, 230B have a plurality of sets of cutouts 271-273.

A set of cutouts 271-273 faces pixel electrode 190 and includes a lower cutout 272, a center cutout 271, and an upper cutout 273. Each of the cutouts 271-273 is disposed between adjacent cutouts 91-92b of pixel electrode 190 or between cutouts 92a or 92b and the chamfered edge of pixel electrode 190. In addition, each of cutouts 271-273 has at least an oblique portion extending parallel to either lower cutout 92a or upper cutout 92b, and the distances between the parallel portions of adjacent cutouts 271-273 and 91-92b, or a cutout and the chamfered edges of pixel electrode 190, are substantially the same. Cutouts 271-273 are substantially symmetrical with respect to the above-described transverse line bisecting pixel electrode 190.

Each of the lower and upper cutouts 272 and 273 includes an oblique portion that extends approximately from the left edge of pixel electrode 190 towards the lower or upper edge of pixel electrode 190, and transverse and longitudinal portions that extend from each end of the oblique portion along the edges of pixel electrode 190. The transverse and longitudinal portions also overlap the edges of the pixel electrode 190 and form obtuse angles with their respective oblique portions.

Center cutout 271 includes a central transverse portion overlapping and extending approximately from the left edge of pixel electrode 190, having an end with a pair of oblique portions, which extend towards a right edge of pixel electrode 190 and form obtuse angles with the central transverse portion. Center cutout 271 also includes a pair of terminal longitudinal portions that extend from each end of the respective oblique portions along the right edge of pixel electrode 190. These terminal longitudinal portions overlap the right edge of pixel electrode 190, and form obtuse angles with the respective oblique portions.

The number of cutouts 271-273 may vary depending on design factors, and light blocking member 220 may also overlap cutouts 271-273 to block light leakage.

The numbers of cutouts 271-273 are patterned when color filters 230R, 230G, 230B are formed without an additional photolithography process.

An overcoat that prevents exposure of color filters 230R, 230G, 230B and provides a flat surface may be formed on color filters 230R, 230G, 230B and light blocking member 220.

A common electrode 270, preferably made of transparent conductive material such as ITO and IZO, is formed on color filters 230R, 230G, 230B.

The surface of common electrode 270 is crooked, or non-planar, depending on cutouts 271-273 in color filter 230R, 230G, 230B, and the crooked surface of common electrode 270 is substantially the same shape as that of cutouts 271-273.

Alignment layers 11 and 21, which may be homeotropic, are coated on the inner surfaces of panels 100 and 200, and polarizers 12 and 22 are provided on the outer surfaces such that their polarization axes may be crossed and one of the transmissive axes may be parallel to gate lines 121. One of the polarizers may be omitted when the LCD is a reflective LCD.

The LCD may further include at least one retardation film (not shown) for compensating the retardation of LC layer 300. The retardation film has birefringence and gives a retardation opposite to that given by LC layer 300. The retardation film may include uniaxial or biaxial optical compensation film, in particular, a negative uniaxial compensation film.

The LCD may further include a backlight unit (not shown) supplying light to LC layer 300 through polarizers 12 and 22, the retardation film, and panels 100 and 200.

It is preferable when LC layer 300 has negative dielectric anisotropy and is operated in a vertical alignment mode that LC molecules 3 are aligned such that their longitudinal axes are substantially vertical to the surfaces of panels 100 and 200 in the absence of an electric field.

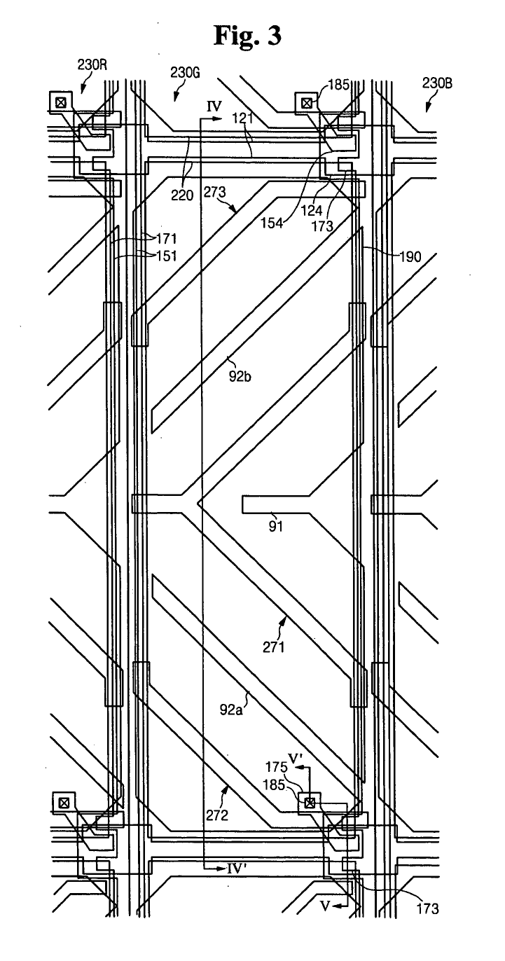

As shown in FIG. 3, a set of cutouts 271-273 and 91-92b divides a pixel electrode 190 into a plurality of sub-areas, or domains, and each sub-area has two major edges.

Cutouts 91-92b and 271-273 and the slope members control the tilt directions of LC molecules 3 in LC layer 300. This will be described in detail.

Upon application of the common voltage to common electrode 270 and a data voltage to pixel electrodes 190, an electric field is generated that is substantially perpendicular to the surfaces of panels 100 and 200. LC molecules 3 tend to change their orientation in response to the electric field such that their longitudinal axes are perpendicular to the field direction.

Cutouts 91-92b and 271-273 of electrodes 190 and 270, respectively, and the edges of pixel electrodes 190 distort the electric field to have a horizontal component that is substantially perpendicular to the edges of cutouts 91-92b and 271-273 and the edges of pixel electrodes 190. Accordingly, LC molecules 3 on each sub-area are tilted in a direction by this horizontal component and the azimuthal distribution of the tilt directions is localized to four directions, thereby increasing the viewing angle of the LCD.

At least one of the cutouts 91-92b and 271-273 can be substituted with protrusions (not shown) or depressions (not shown). The protrusions are preferably made of organic or inorganic material and disposed on or under the field-generating electrodes 190 or 270.

The shapes and the arrangements of protrusions and cutouts 91-92b and 271-273 may be modified.

Since the tilt directions of all domains form approximately a 45-degree angle with gate lines 121, which are either parallel or perpendicular to the edges of panels 100 and 200, and the 45-degree intersection of the tilt directions and the transmissive axes of polarizers 12 and 22 provides maximum transmittance, polarizers 12 and 22 can be attached such that their transmissive axes are parallel or perpendicular to the edges of the panels 100 and 200, thereby reducing production costs.

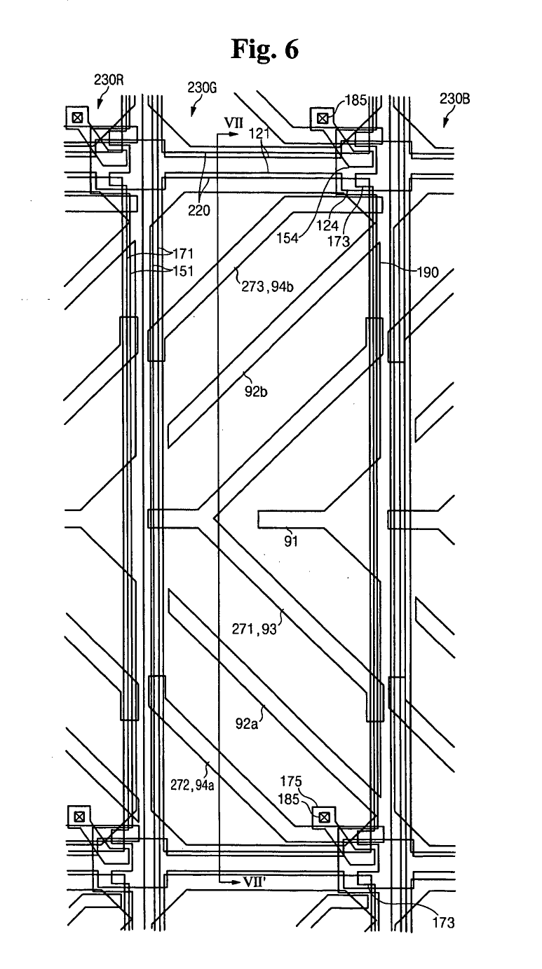

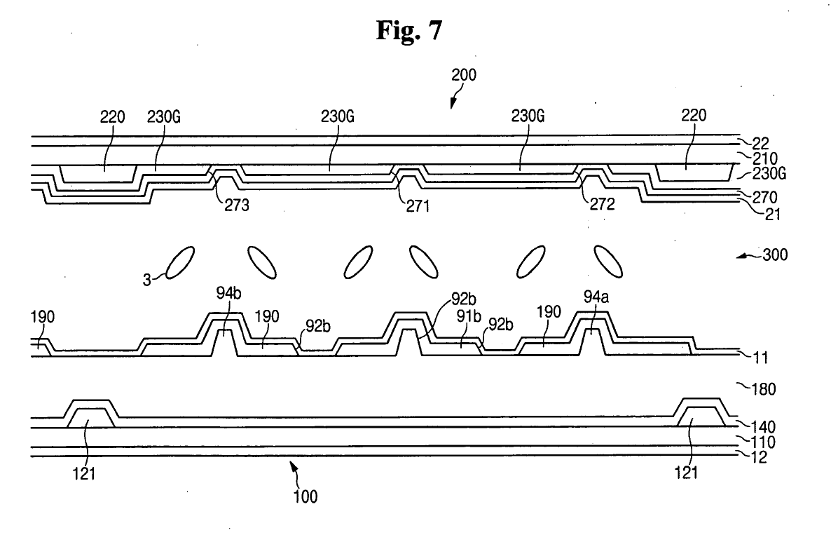

An LCD according to another embodiment of the present invention will be described in detail with reference to FIGS. 6 and 7.

As shown in FIGS. 6 and 7, the LCD according to this embodiment of the present invention also includes TFT array panel 100, common electrode panel 200, LC layer 300 interposed between panels 100 and 200, and a pair of polarizers 12 and 22 attached to the outer surfaces of panels 100 and 200.

The layered structures of panels 100 and 200 are almost the same as those shown in FIGS. 1-5.

In contrast to the LCD shown in FIGS. 1-5, passivation layer 180 has a plurality of linear protrusions 93-94b, which are respectively located in the same positions as cutouts 271-273 in color filters 230R, 230G, 230B.

Upon the application of the common voltage to common electrode 270 and a data voltage to pixel electrodes 190, the equipotential lines of the electric field are substantially parallel to the surfaces of panels 100 and 200. However, the equipotential lines of the electric field on the circumference of protrusions 93-94b and cutouts 271-273 are curved due to the crooked, or non-planar, surfaces of electrodes 270 and 190 due to the shape of protrusions 93-94b and cutouts 271-273.

These curved equipotential lines determine the tilt direction of LC molecules 3 upon application of an electric field in concert with cutouts 271-273 and protrusions 93-94b. The tilt directions of individual LC molecules 3 will vary based on their proximity to cutouts 271-273 and protrusions 93-94b.

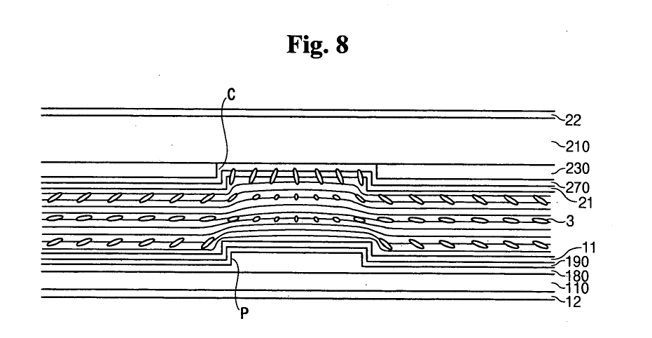

FIG. 8 is a sectional view showing equipotential lines formed between a TFT array panel and a common electrode panel of an LCD according to the present invention.

FIG. 8 shows a LCD including a TFT array panel 100 comprising a passivation layer 180 including a protrusion P and formed on an insulating substrate 110, a pixel electrode 190 and an alignment layer 11; and a common electrode panel 200 comprising a color filter 230 including a cutout C, a common electrode 270 and an alignment layer 21

In FIG. 8, a plurality of signal lines, a plurality of thin film transistors and a black matrix are omitted, but protrusion P and cutout C, which are located at the same position as the omitted elements, are shown.

As shown in FIG. 8, an electric field having equipotential lines substantially parallel to the surfaces of the panels 100 and 200 is formed when voltages are applied to common electrode 270 and pixel electrodes 190. However, the curved equipotential lines of the electric field on the circumference of the protrusion P and the cutout C are curved due to the crooked surfaces of electrodes 270 and 190 that are due to the shape of protrusion P and cutout C. Accordingly, the tilt directions of LC molecules 3 in proximity to cutout C and the protrusion C are substantially symmetrical with respect to cutout C and protrusion P.

The number of the domains can be varied by changing the number of cutouts and protrusions in the passivation layer and color filters, or by changing the number of curved points on the edges of pixel electrodes 190 in the above-described LCD.

In the above-described LCD according to the present invention, although there is no cutout in the common electrode panel, a plurality of cutouts in the color filters formed under the common electrode can also influence tilt directions along with the protrusions of the passivation layer and the cutouts of the pixel electrodes, and then a plurality of domains based on the tilt directions of the LC molecules 3 can be provided. Accordingly, the omission of the cutout removes a lithography step for forming cutouts in common electrode 270, and the omission of the cutout prevents the accumulation of charge carriers that can damage polarizers 12 and 22, thereby obviating the need for an ESD treatment. Therefore, omitting cutouts in the common electrode remarkably reduces the cost of manufacturing the LCD, and a method for manufacturing the LCD may be simplified.

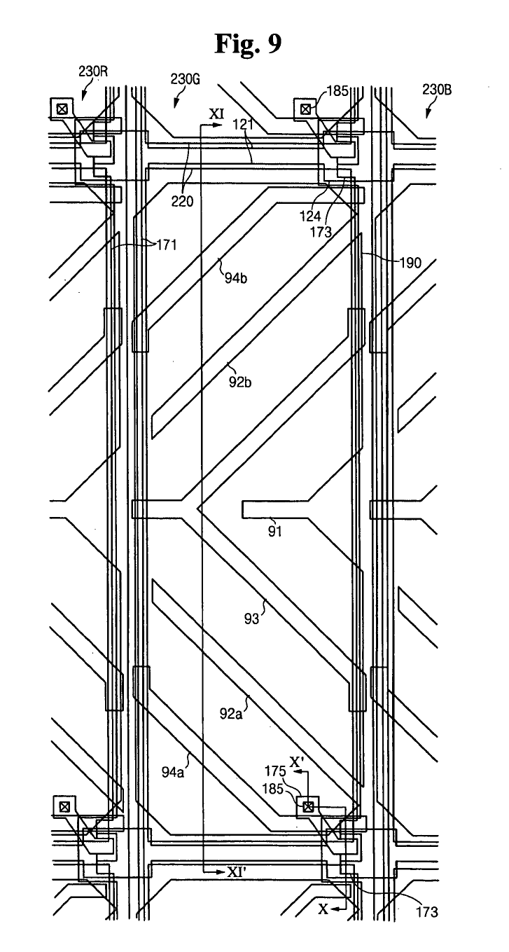

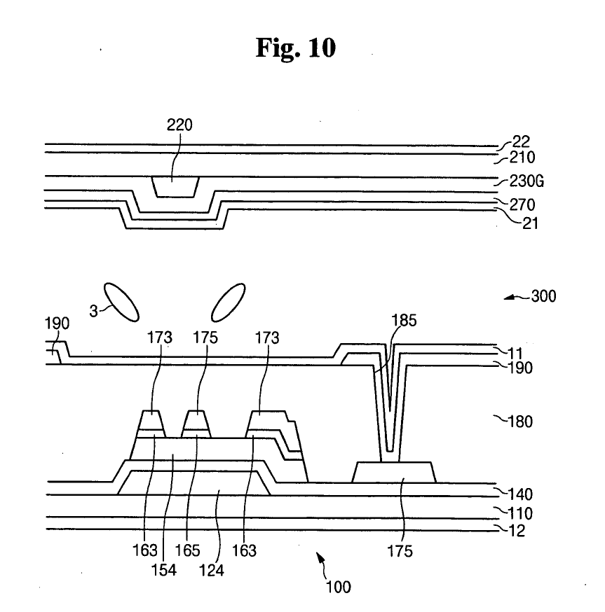

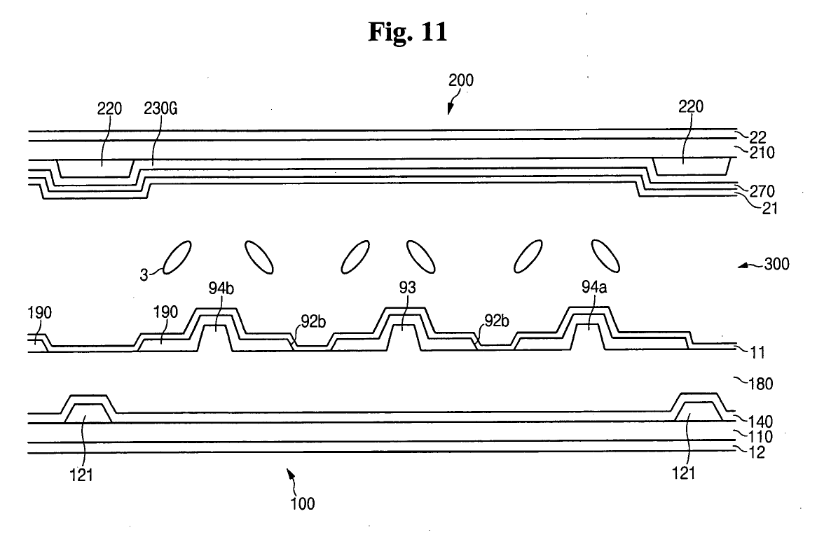

An LCD according to yet another embodiment of the present invention will be described in detail with reference to FIGS. 9-11.

As shown in FIGS. 9-11, an LCD according to this embodiment of the present invention also includes a TFT array panel 100, a common electrode panel 200, a LC layer 300 interposed between the panels 100 and 200, and a pair of polarizers 12 and 22 attached on outer surfaces of the panels 100 and 200.

Once again, the layered structures of panels 100 and 200 are almost the same as those shown in FIGS. 1-5.

In contrast to the LCD depicted in FIGS. 1-5, semiconductor stripes 151 of TFT array panel 100 according to this embodiment have almost the same planar shapes as data lines 171 and drain electrodes 175 as well as underlying ohmic contacts 163 and 165. However, projections 154 of the semiconductor stripes 151 include exposed portions, which are not covered by data lines 171 and the drain electrodes 175, like those portions located between source electrodes 173 and drain electrodes 175.

Furthermore, like FIGS. 6 and 7, passivation layer 180 has a plurality of protrusions 93-94b, which are respectively located between cutouts 91-92, and the chamfered is corners on the left edge of the pixel electrode 190, but here color filters 230R, 230G, 230B have no cutouts.

A manufacturing method of the TFT array panel according to an embodiment of the present invention simultaneously forms data lines 171, drain electrodes 175, metal pieces, semiconductors 151, and ohmic contacts 163 and 165 using one photolithography process.

A photoresist pattern for the photolithography process has a position-dependent thickness, and in particular, it has first and second portions with decreased thickness. The first portions are located on wire areas that will be occupied by data lines 171, the drain electrodes 175, and the metal pieces and the second portions are located on channel areas of TFTs.

The position-dependent thickness of the photoresist is obtained by several techniques, for example, by providing translucent areas on the exposure mask as well as transparent and light blocking opaque areas too. The translucent areas may have a slit pattern, a lattice pattern or thin film(s) with intermediate transmittance or intermediate thickness. When using a slit pattern, it is preferable that the width of the slits, or the distance between the slits, is smaller than the resolution of a light exposer used for the photolithography. Another example is to use reflowable photoresist. In particular, once a photoresist pattern of only with transparent areas and opaque areas is made from a reflowable material by using a normal exposure mask, the reflowable material may flow onto areas without the photoresist, thereby forming thin film portions.

As a result, the manufacturing process is simplified by omitting a photolithography step.

Many of the above-described features of the LCD shown in FIGS. 1-5 may be appropriate to the TFT array panel shown in FIGS. 9-11.

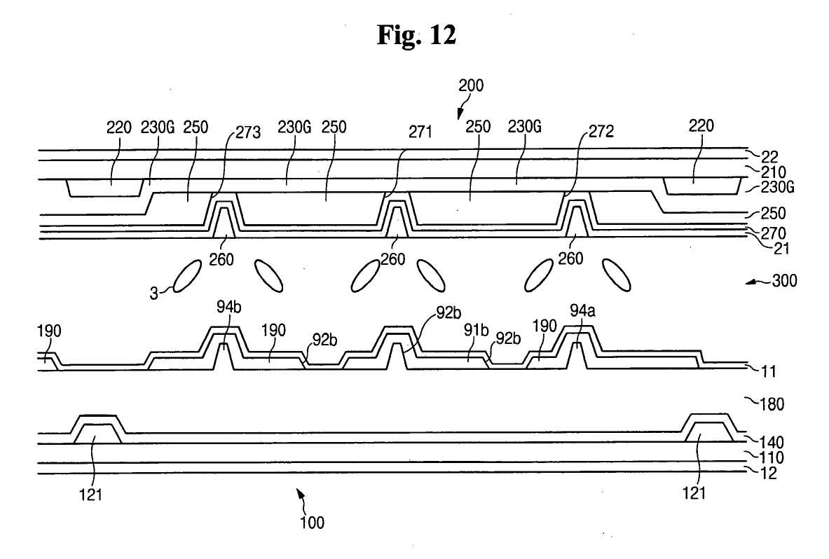

An LCD according to yet another embodiment of the present invention will be described in detail with reference to FIG. 12.

As shown in FIG. 12, an LCD according to this embodiment the present invention also includes a TFT array panel 100, a common electrode panel 200, a LC layer 300 interposed between the panels 100 and 200, and a pair of polarizers 12 and 22 attached on the outer surfaces of panels 100 and 200.

As in the other embodiments described herein, the layered structures of the panels 100 and 200 according to this embodiment are almost the same as those shown in FIGS. 1-5.

In contrast to the LCD shown in FIGS. 1-5, an overcoat layer 250 is inserted between common electrode 270 and color filter 230, and has a set of cutouts 271-273 facing pixel electrode 190 instead of the color filters 230R, 230B, 230G. Color filter 230 has no cutouts. Overcoat 250 prevents the resin of color filter 230 from moving to common electrode 270, and improves the flatness of common electrode panel 200. Because common electrode 270 is formed on overcoat 250, common electrode 270 has crooked portions formed by cutouts 271-273 in overcoat 250.

In the above-described LCD, organic insulator 260 fills up the sunken portion of common electrode 270 due to cutouts 271-273 in overcoat 250. Organic insulator 260 has a dielectric constant (ε) equal to or smaller than the liquid crystal layer, preferably less than 3. Organic insulator 260 filled in the sunken portion increases the inclination of equipotential lines formed on the cutouts, which facilitates the alignment of LC molecules 3.

Many of the above-described features of the LCD shown in FIG. 12 may be appropriate to the LCD array panel shown in FIGS. 1-11.

The domain control means may be provided to field-generating electrodes by forming cutouts or protrusions in the insulating layer or color filters without additional photolithography steps. Accordingly, a method for manufacturing the LCD may be simplified.

Also, the omission of the cutout in the common electrode prevents the accumulation of charge carriers that can damage the polarizers, thereby obviating the need for an ESD treatment. Therefore, the omission of the cutout in the common electrode remarkably reduces the cost for manufacturing the LCD, and a method for manufacturing the LCD may be simplified.

While the present invention has been described in detail with reference to the preferred embodiments, those skilled in the art will appreciate that various modifications and substitutions can be made thereto without departing from the spirit and scope of the present invention as set forth in the appended claims.

1. A liquid crystal display panel, comprising:
a substrate;
a gate line and a data line formed on the substrate;
a thin film transistor connected to the gate line and the data line;
a passivation layer including a set of protrusions that form a plurality of domains, wherein the passivation layer covers the gate line, the data line and the thin film transistor; and
a pixel electrode formed on the passivation layer and connected to the thin film transistor, wherein the pixel electrode includes a non-planar surface induced by the protrusions on the passivation layer.

2. The liquid crystal display panel of claim 1, wherein the protrusions are linear.

3. The liquid crystal display panel of claim 1, wherein the pixel electrode includes a set of cutouts.

4. The liquid crystal display panel of claim 3, wherein the protrusions and the cutouts are alternately arranged so that no domain in the plurality of domains is formed by two protrusions or two cutouts.

5. The liquid crystal display panel of claim 1, wherein the thin film transistor comprises a gate electrode connected to the gate line, a source electrode connected to the data line, a drain electrode, and a semiconductor layer that is in electrical contact with the source and drain electrodes and overlaps the gate electrode.

6. The liquid crystal display panel of claim 5, further comprising an ohmic contact layer formed between the the semiconductor layer and the source and drain electrodes.

7. A liquid crystal display panel, comprising:
a substrate;
an insulating layer formed on the substrate, wherein the insulating layer includes a set of cutouts that form a plurality of domains; and
a common electrode formed on the insulating layer, wherein the common electrode includes a non-planar surface induced by the cutouts in the insulation layer.

8. The liquid crystal display panel of claim 7, wherein the insulating layer is a color filter.

9. The liquid crystal display panel of claim 7, further comprising a color filter formed under the insulating layer.

10. The liquid crystal display panel of claim 7, further comprising an insulator formed in a sunken portion of the non-planar surface of the common electrode induced by a cutout in the insulating layer.

11. The liquid crystal display panel of claim 10, wherein the dielectric constant (ε) of the insulator is less than 3.

12. A liquid crystal display, comprising:
a first substrate;
a gate line and a data line formed on the first substrate;
a thin film transistor connected to the gate line and the data line;
a passivation layer including a set of protrusions that form a plurality of domains, wherein the passivation layer covers the gate line, the data line and the thin film transistor;
a pixel electrode formed on the passivation layer and connected to the thin film transistor, wherein the pixel electrode includes a non-planar surface induced by the protrusions on the passivation layer;
a second substrate;
an insulating layer formed on the second substrate; and
a common electrode formed on the insulating layer.

13. The liquid crystal display of claim 12, wherein the insulating layer includes a set of cutouts that form a plurality of domains.

14. The liquid crystal display of claim 13, wherein each protrusion overlaps a corresponding cutout and have the same relative positions on the respective first and second substrate.

15. The liquid crystal display of claim 12, wherein the common electrode includes a non-planar surface induced by the cutouts in the insulating layer.

16. The liquid crystal display of claim 12, wherein the pixel electrode includes a set of cutouts.

17. The liquid crystal display of claim 16, wherein the protrusions and the cutouts of the pixel electrode are alternately arranged on a non-planar surface of the pixel electrode such that no cutout is adjacent to another cutout.

18. A liquid crystal display, comprising:
a first substrate;
a gate line and a data line formed on the first substrate;
a thin film transistor connected to the gate line and the data line;
a passivation layer covering the gate line, the data line and the thin film transistor;
a pixel electrode formed on the passivation layer and connected to the thin film transistor;
a second substrate;
an insulating layer formed on the second substrate, wherein the insulating layer includes a set of cutouts that form a plurality of domains; and
a common electrode formed on the insulating layer, wherein the common electrode includes a non-planar surface induced by the cutouts in the insulation layer.

19. The liquid crystal display of claim 18, wherein the passivation layer includes a set of protrusions that form a plurality of domains.

20. The liquid crystal display of claim 19, wherein the pixel electrode includes a non-planar surface induced by the protrusions on the passivation layer.

21. The liquid crystal display panel of claim 18, wherein the insulating layer is a color filter.

22. The liquid crystal display panel of claim 18, further comprising a color filter formed under the insulating layer.

23. The liquid crystal display panel of claim 18, further comprising an insulator formed in a sunken portion of the non-planar surface of the common electrode induced by a cutout in the insulating layer.

24. The liquid crystal display panel of claim 23, wherein the dielectric constant (ε) of the insulator is less than 3.
